(19) United States
(12) Patent Application Publication
(10) Pub. No.: US 2008/0268227 A1
(43) Pub. Date: Oct. 30, 2008

(54) Complex polishing pad and method for making the same

(76) Inventors: Chung-Chih Feng, Kaohsiung (TW); I-Peng Yao, Kaohsiung (TW); Lyang-Gung Wang, Kaohsiung (TW); Yung-Chang Hung, Kaohsiung (TW)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/790,961

(22) Filed: Apr. 30, 2007

(51) Int. Cl. B32B 3/00; B05D 5/00

(52) U.S. Cl. 428/316.6; 427/243

(57) ABSTRACT

The present invention relates to a complex polishing pad and method for making the same. The method of the invention comprises the steps of: (a) providing a buffer layer, the buffer layer being continuous-porous material and having a surface; (b) flattening the surface of the buffer layer to form a flattened surface; and (c) disposing a polishing layer on the flattened surface so as to form the complex polishing pad, wherein the polishing layer is used to polish a polishing workpiece. Whereby, the complex polishing pad of the invention has a better flatness, and the buffer layer and the polishing layer have a stronger combination.

### BACKGROUND OF THE INVENTION

1. Field of the Invention

The present invention relates to a polishing pad and a method for making the same. More particularly, the present invention relates to a complex polishing pad and a method for making the same.

2. Description of the Related Art

A common polishing is using a chemical mechanical polishing (CMP) process to polish a rough surface, in which a slurry containing polishing particles is uniformly distributed on the surface of a polishing pad. Meanwhile, after a polishing workpiece is rest on the polishing pad, a repeated and regulate rubbing and polishing action is performed. The polishing workpiece is an object, such as semiconductor, storage medium buffer layer, integrated circuit, LCD flat panel glass, optical glass, and photoelectric panel.

In the conventional single-layer independent foaming polishing layer, the distribution and size of the foaming pores generated during the process are unlikely to be made uniform due to the slurry concentration and the molding temperature, resulting in the instability of the quality of the conventional polishing layer. In another conventional polishing layer formed by an independent non-foaming resin, the polishing surface has no fine pores, such that the slurry cannot be maintained between the polishing layer and the polishing article, thereby alleviating the polishing efficacy.

FIG. 6 shows a conventional complex polishing pad, which is formed by directly coating a polymer elastomer on a buffer layer and solidifying the two into a complex polishing pad. In the conventional buffer layer, the polymer elastomer coated on the buffer layer will be uneven (i.e., the interface of the polymer elastomer film and the buffer layer is uneven) due to the poor flatness of the non-woven fabric and the difference in the cotton content. Therefore, the polishing efficacy is poor, and the polishing article may even be damaged.

Another conventional complex polishing pad is formed by the following steps: directly coating a polymer elastomer on a buffer layer; obtaining a polymer elastomer film by solidifying and slicing; and then adhering the polymer elastomer film to another buffer layer with a double-sided tape. However, the polymer elastomer film obtained through slicing may be uneven due to differences in the equipment and the cotton content.

Referring to FIG. 7, a conventional buffer layer having an uneven surface is shown. FIG. 8 shows the uneven surface of the attached double-sided tape. Referring to FIG. 9, an uneven adhesive surface of the polymer elastomer film and the buffer layer after being adhered with a double-sided tape is shown. It can be clearly seen from FIGS. 7 to 9 that the surface of the complex polishing pad made by the conventional making method and the adhesive surface of the polymer elastomer film and the buffer layer both are uneven surfaces.

Accordingly, the conventional complex polishing pad has a surface of poor flatness, and thus the polishing effect is poor. Furthermore, in the conventional technique, the polymer elastomer film and the buffer layer are adhered with a double-sided tape, and the polymer elastomer film and the buffer layer both have an uneven surface, so the combination between the polymer elastomer film and the buffer layer is weak.

Consequently, there is an existing need for providing a complex polishing pad and method for making the same to solve the above-mentioned problems.

### SUMMARY OF THE INVENTION

An objective of the present invention is to provide a complex polishing pad. The complex polishing pad comprises a buffer layer and a polishing layer. The buffer layer is of a continuous-porous material, and has a flattened surface. The polishing layer is of a continuous-porous material, disposed on the flattened surface, so as to form a complex polishing pad, in which the polishing layer is used to polish a polishing workpiece.

Another objective of the present invention is to provide a method for making a complex polishing pad. The making method comprises: (a) providing a buffer layer, in which the buffer layer is of a continuous-porous material and has a surface; (b) flattening the surface of the buffer layer to form a flattened surface; and (c) disposing a polishing layer on the flattened surface, so as to form a complex polishing pad, in which the polishing layer is of a continuous-porous material and is used to polish a polishing workpiece.

A buffer layer with an extremely flat surface can be generated according to the making method of the present invention, such that the polishing layer disposed on the flattened surface also has an extremely flat surface. Therefore, during the polishing process of the complex polishing pad of the present invention, a uniform force is applied to the surface of a polishing workpiece, such that the polishing workpiece after being polished has a flatter surface, and the polishing workpiece may not be scratched or damaged. Thus, the complex polishing pad of the present invention has a preferred polishing effect. Additionally, the complex polishing pad has a better flatness, and thus the buffer layer and the polishing layer have a stronger combination.

### BRIEF DESCRIPTION OF THE DRAWINGS

FIG. 1A is a schematic diagram of a non-woven fabric of the present invention;

FIG. 1B is a schematic diagram of the non-woven fabric immersed in a polymer solution according to the present invention;

FIG. 1C is a schematic diagram of an initial buffer layer of the present invention;

FIG. 1D is a schematic diagram of a buffer layer formed by slicing the initial buffer layer according to the present invention;

FIG. 1E is a schematic diagram of flattening a surface of the buffer layer according to the present invention;

FIG. 1F is a schematic diagram of a complex polishing pad according a first embodiment of the present invention;

FIG. 2A is a schematic diagram of a carrier of the present invention;

FIG. 2B is a schematic diagram of a polishing layer formed by coating a polymer composition on the carrier according to the present invention;

FIG. 2C is a schematic diagram of separating the carrier and the polishing layer according to the present invention;

FIG. 3 is a schematic diagram of the polishing layer surface having a plurality of polymer elastic fluffs of the present invention;

FIG. 4 is a schematic diagram of forming a plurality of grooves in the polishing layer according to the present invention;

FIG. 5 is a schematic diagram of a complex polishing pad according to a second embodiment of the present invention;

FIG. 6 is a schematic diagram of a conventional complex polishing pad;

FIG. 7 is a schematic diagram of a conventional buffer layer having an uneven surface;

FIG. 8 is a schematic diagram of a conventionally attached double-sided tape having an uneven surface; and

FIG. 9 is a schematic diagram of an uneven adhesive surface of the polymer elastomer film and the buffer layer after being adhered by a conventional double-sided tape.

### DETAILED DESCRIPTION OF THE INVENTION

The present invention provides a complex polishing pad, which is used in a chemical mechanical polishing (CMP) process for polishing or planarizing a polishing workpiece. The polishing workpiece comprises, but not limited to, objects such as semiconductor, storage medium buffer layer, integrated circuit, LCD flat panel glass, optical glass, and photoelectric panel.

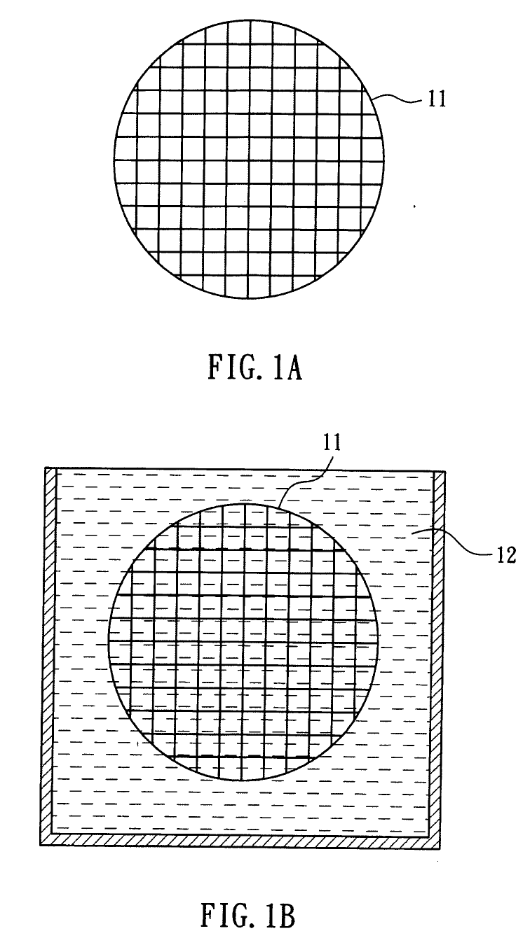

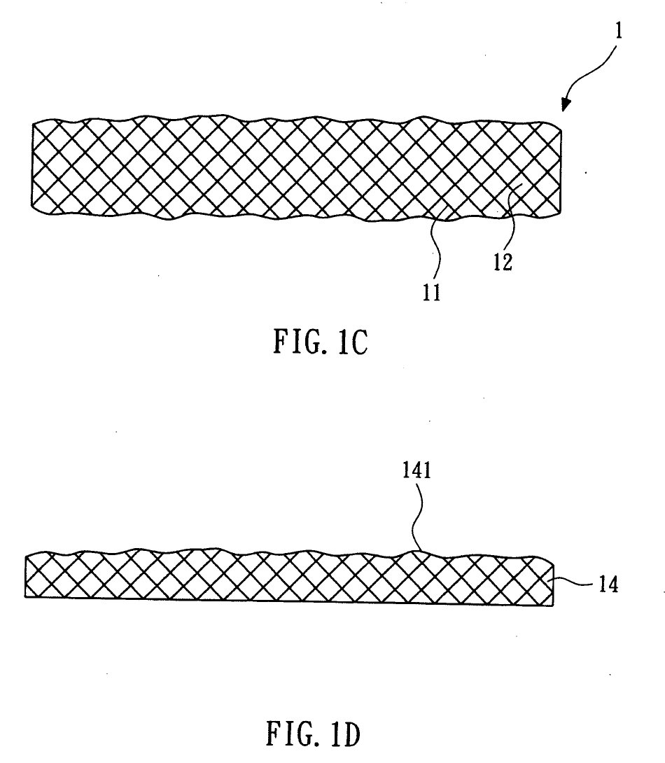

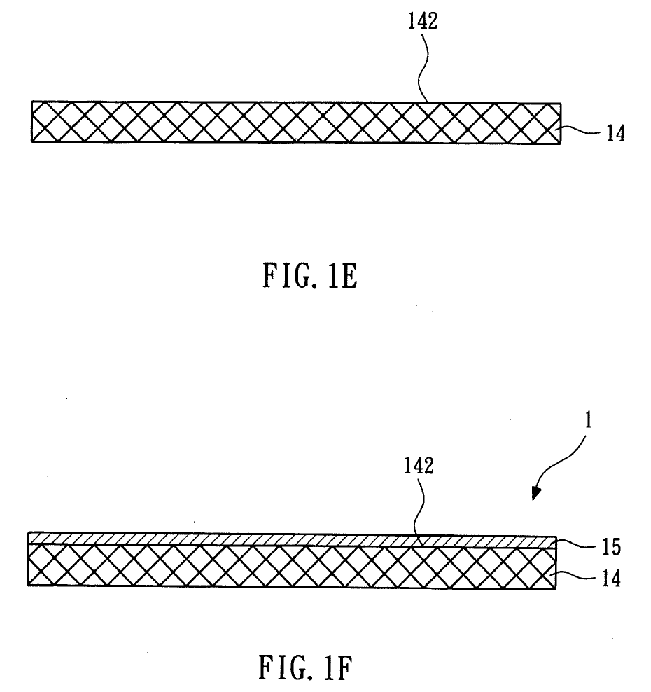

Referring to FIG. 1A to FIG. 3, a method of making a complex polishing pad according to a first embodiment of the present invention is shown. Referring to FIG. 1A, first, a non-woven fabric 11 is provided. Referring to FIG. 1B, the non-woven fabric 11 is immersed in a polymer solution 12. Referring to FIG. 1C, the non-woven fabric 11 containing the polymer solution 12 is solidified to form an initial buffer layer 13 by a baking step. Moreover, the method of the invention preferably comprises a step of coagulating the polymer solution 12 contained in the non-woven fabric 1 before the baking step, and the method of the invention preferably comprises a step of water-washing the non-woven fabric 11 after the step of coagulating the polymer solution 12.

Referring to FIG. 1D, the initial buffer layer 13 is sliced to form a buffer layer 14, which has a surface 141. The buffer layer 14 is a continuous porous foaming polymer elastomer.

Referring to FIG. 1E, the surface 141 of the buffer layer 14 is flattened, such that the surface is formed into a flattened surface 142. Preferably, the unflatness percentage of the flattened surface is less than 6.0%. In the embodiment, the surface 141 is flattened by grinding. The unflatness percentage of the flattened surface 142 after being grinded can be effectively reduced to a value between 1.8% and 1.9%. Preferably, the method of the invention preferably comprises a step of smoothing the flattened surface 142 after grinding step, so as to increase the flatness of the flattened surface 142.

In the embodiment, the flatness of the flattened surface 142 is calculated by means of standard deviation, and the calculation equation is as follows:

$$Unflatness percentage = \frac{\begin{matrix}Maximum thickness of a plurality of points - minimum \\ thickness of a plurality of points\end{matrix}}{Average thickness of a plurality of pointsx 2} \times 100 \%$$

Referring to FIG. 1F, a polishing layer 15 is disposed on the flattened surface 142 of the buffer layer 14, so as to form a complex polishing pad 1. The polishing layer 15 is a continuous-porous polymer elastic sheet, and is used to polish a polishing workpiece. It should be noted that the polishing layer 15 may also have a plurality of polishing particles (not shown) uniformly distributed in the polishing layer 15, so as to enhance the efficacy of surface polishing.

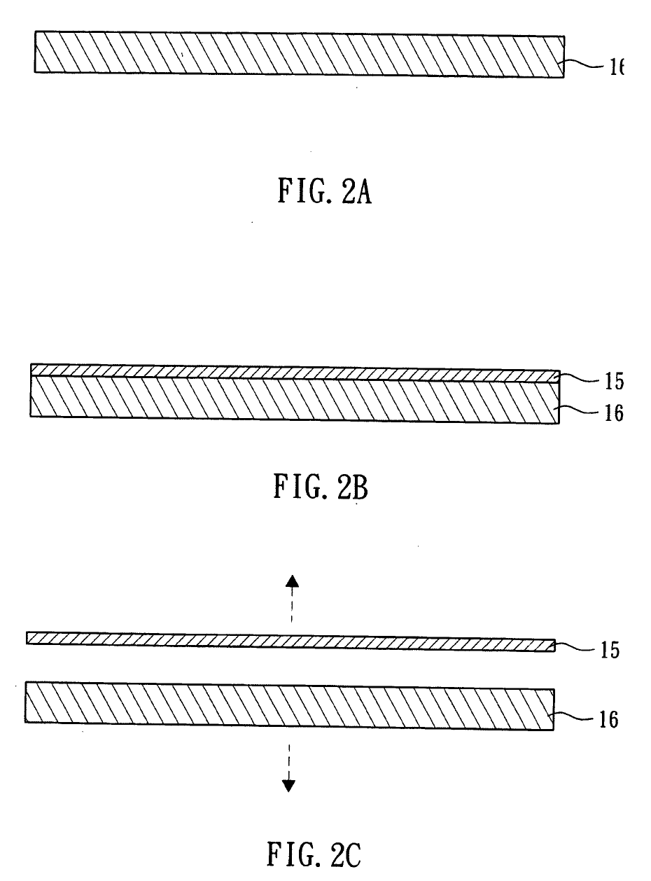

Referring to FIG. 2A to FIG. 2C, the polishing layer 15 is formed by the following steps. First, a carrier 16 is provided; next, a polymer composition is coated on the carrier 16; then, the polymer composition is solidified to form the polishing layer 15; and finally, the carrier 16 and the polishing layer 15 are separated. In the embodiment, the carrier 16 is an impermeable film, and the surface of the carrier 16 is a smooth surface or a gloss surface, such that the polishing layer 15 has a better uniformity and flatness. Preferably, the material of the carrier 16 is selected from a group consisting of polyester (PET), oligo(phenylene ethynylene) (OPP), polyolefin (TPE), polystyrene (PS), polypropylene (PP), polyethylene (PE), polyurethane (PU), or a combination thereof. In the embodiment, the carrier 16 and the polishing layer 15 are separated through a mechanical physical manner. In other applications, the carrier 16 and the polishing layer 15 can also be separated through a chemical manner.

Referring to FIG. 1F and FIG. 2C, it should be noted that a selective step of grinding and leveling the polishing layer 15 can be preferably performed before separating the carrier 16 and the polishing layer 15, or a selective step of grinding and leveling the polishing layer 15 can be preferably performed after disposing the polishing layer 15 on the flattened surface 142 of the buffer layer 14, so as to improve the flatness of the polishing layer 15, and such that the complex polishing pad 1 has a more uniform thickness. Therefore, when polishing a polishing workpiece, a uniform force is applied to the surface of the polishing workpiece, so as to improve the polishing quality.

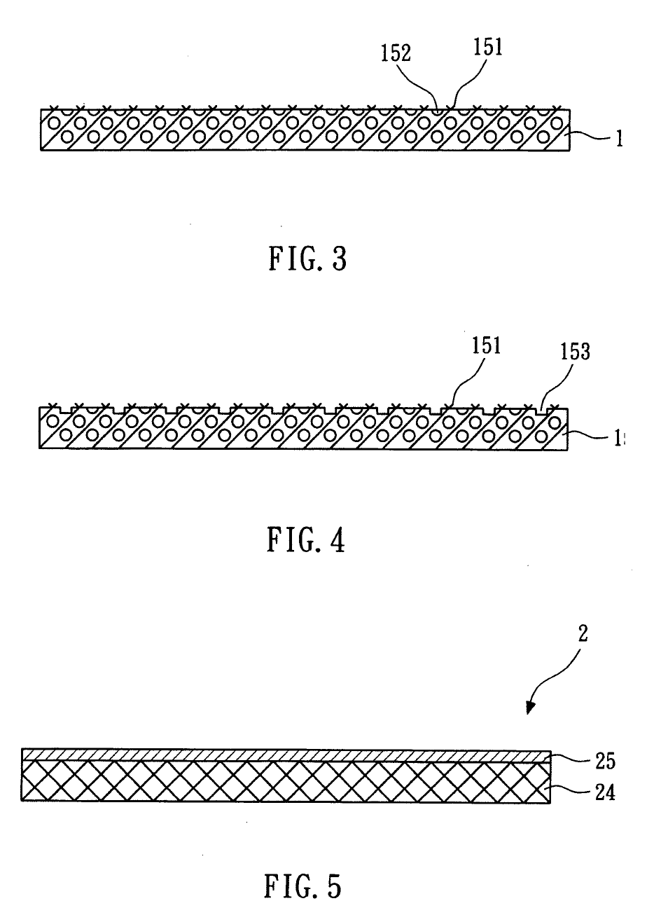

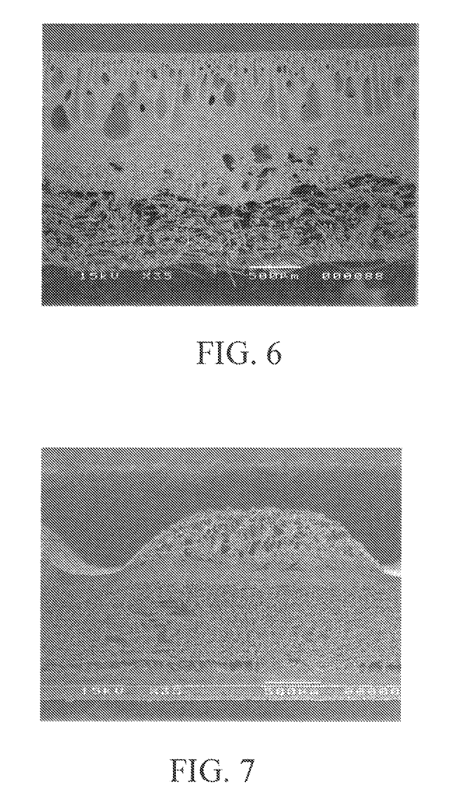

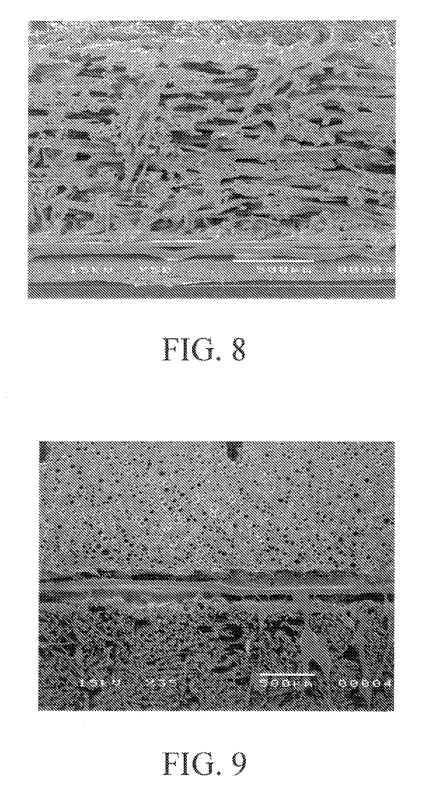

Referring to FIG. 1F and FIG. 3, after the polishing layer 15 is grinded, a plurality of polymer elastic fluffs 151 reveal on the surface of the polishing layer 15. Moreover, as the polishing layer 15 is a continuous-porous polymer elastic sheet, a plurality of openings 152 is also generated. Thereby, during polishing, the slurry applied between the complex polishing pad 1 and the polishing workpiece is increased, so as to make the distribution of the polishing particles in the slurry more uniform.

Referring to FIG. 1F and FIG. 4, preferable, after combining the buffer layer 14 and the polishing layer 15, the method of the invention preferably further comprises a step of forming a plurality of grooves 153 on the polishing layer 15. According to different applications, the grooves 153 can be of geometric configurations of square, triangle, or rectangle.

Referring to FIG. 5, a method of making a complex polishing pad according to a second embodiment of the present invention is shown. The difference between the methods of making a complex polishing pad according to the second embodiment and that of the first embodiment is that in the method of making a complex polishing pad according to the second embodiment, a polymer composition is directly coated on a buffer layer 24 after being grinded and leveled, and then solidifying the polymer composition, so as to form a polishing layer 25 to fabricate a complex polishing pad 2.

Similarly, after the solidifying step, the method of the invention preferably further comprises a step of grinding and leveling the polishing layer 25, so as to enhance the flatness of the polishing layer 25, and increase the uniformity of the thickness of the complex polishing pad 2. Additionally, after the step of polishing, the method of the invention preferably further comprises a step of forming a plurality of grooves in the polishing layer 25. According to different applications, the grooves can be of geometric configurations of square, triangle, or rectangle.

Referring to FIG. 1F again, a schematic diagram of the complex polishing pad according to the first embodiment of the present invention is shown. The complex polishing pad 1 comprises a buffer layer 14, and a polishing layer 15. The buffer layer 14 has a flattened surface 142, and the unflatness percentage of the flattened surface 142 is less than 6%. Preferably, the buffer layer 14 is a continuous porous foaming polymer elastomer. Preferably, the buffer layer 14 is selected from a group consisting of PET, OPP, TPE, PS, PP, PE, PU, or a combination thereof.

The polishing layer 15 is disposed on the flattened surface 142, so as to form the complex polishing pad 1. In the embodiment, the polishing layer 15 is a continuous-porous polymer elastic sheet, used for polishing a polishing workpiece, and has a plurality of polishing particles (not shown) uniformly distributed in the polishing layer 15.

The present invention will be described in detail in the following embodiments. However, the present invention is not limited to the disclosure of the following embodiments.

### Embodiment 1

First, a non-woven fabric is immersed in a continuous porous foaming PU polymer solution; after solidifying, the non-woven fabric containing PU polymer solution is sliced to have a thickness of about 1.1 mm; and after surface grinding, trimming, and smoothing, a buffer layer having a flattened surface is formed.

Additionally, an OPP film having a thickness of 0.03 mm is used as a carrier, and a polymer elastomer having a thickness of 1.0-1.1 mm is coated on the surface of the carrier. Next, the polymer elastomer is solidified by 25% of dimethylformamide (DMF). The solidified polymer elastomerhas a thickness of about 0.65 mm. Afterward, the polymer elastomer is water-washed at 75° C.-80° C., and a baking step is then performed at 130° C., such that the baked polymer elastomer has a thickness of about 0.55 mm.

Next, the baked polymer elastomer is separated from the carrier, so as to form a polishing layer. Then, the polishing layer is disposed on the flattened surface of the buffer layer. Finally, the surface of the polishing layer is grinded, such that the overall thickness is about 1.55 mm, and thereby the complex polishing pad of the present invention is performed.

### Embodiment 2

First, a non-woven fabric is immersed in a continuous porous foaming PU polymer solution; after solidifying, the non-woven fabric containing PU polymer solution is sliced to have a thickness of about 1.1 mm; and after surface polishing, trimming, and smoothing, a buffer layer having a flattened surface is formed.

Additionally, a polymer elastomer having a thickness of 1.0-1.1 mm is coated on the flattened surface of the buffer layer, wherein the buffer layer is used as a carrier. Next, the polymer elastomer is solidified by 25% of DMF. The solidified polymer elastomer has a thickness of about 0.65 mm. Afterward, the polymer elastomer is water-washed at 75° C.-80° C., and a baking step is then performed at 130° C., such that the baked polymer elastomer has a thickness of about 0.55 mm.

Next, the baked polymer elastomer is grinded to have an overall thickness of about 1.55 mm, and thereby the complex polishing pad of the present invention is performed.

According to the making method of the present invention, a buffer layer having an extremely flat surface can be made, and thus the polishing layer 15 disposed on the buffer layer 14 also has an extremely flat surface. Therefore, during the polishing of the complex polishing pad 1 of the present invention, a uniform force is applied to the surface of a polishing workpiece, such that the polishing workpiece after being polished may have a flat surface, and may not be scratched or damaged. Thus, the complex polishing pad 1 of the present invention has a preferred polishing effect. In addition, the complex polishing pad 1 has a better flatness, and thus the buffer layer 14 and the polishing layer 15 have a stronger combination.

While the embodiments of the present invention have been illustrated and described, various modifications and improvements can be made by those skilled in the art. The embodiments of the present invention are therefore described in an illustrative but not restrictive sense. It is intended that the present invention may not be limited to the particular forms as illustrated, and that all modifications that maintain the spirit and scope of the present invention are within the scope as defined in the appended claims.

What is claimed is:

1. A complex polishing pad, comprising:
a buffer layer, being of a continuous-porous material, and having a flattened surface; and
a polishing layer, being of a continuous-porous material, and disposed on the flattened surface, so as to form the complex polishing pad, wherein the polishing layer is used to polish a polishing workpiece.

2. The polishing pad according to claim 1, wherein the unflatness percentage of the flattened surface is less than 6.0%.

3. The polishing pad according to claim 1, wherein the buffer layer is a continuous-porous polymer elastomer, and the polishing layer is a continuous-porous polymer elastic sheet.

4. The polishing pad according to claim 3, wherein the buffer layer is selected from a group consisting of polyester (PET), oligo(phenylene ethynylene) (OPP), polyolefin (TPE), polystyrene (PS), polypropylene (PP), polyethylene (PE), polyurethane (PU), or a combination thereof.

5. The polishing pad according to claim 1, wherein the polishing layer has a plurality of polishing particles, and the polishing particles are uniformly distributed in the polishing layer.

6. The polishing pad according to claim 1, wherein the polishing layer has a surface, and the surface has a plurality of polymer elastic fluffs and a plurality of openings.

7. The polishing pad according to claim 1, further comprising a plurality of grooves formed on the polishing layer.

8. The polishing pad according to claim 7, wherein the grooves are of geometric configurations of triangle, square, or rectangle.

9. A method for making a complex polishing pad, comprising:
(a) providing a buffer layer, wherein the buffer layer is of a continuous-porous material and has a surface;
(b) flattening the surface of the buffer layer to form a flattened surface; and
(c) diposing a polishing layer on the flattened surface, so as to form a complex polishing pad, wherein the polishing layer is of a continuous-porous material and is used to polish a polishing workpiece.

10. The method according to claim 9, wherein the buffer layer is formed by the following steps of:
(a1) providing a non-woven fabric;
(a2) immersing the non-woven fabric in a polymer solution;
(a3) solidifying the non-woven fabric having the polymer solution to form an initial buffer layer; and
(a4) slicing the initial buffer layer to form the buffer layer.

11. The method according to claim 10, further comprising a step of water-washing the non-woven fabric containing the polymer solution after a coagulating step to solidify the non-woven fabric.

12. The method according to claim 11, further comprising a baking step to solidify the non-woven fabric containing the polymer solution after the step of water-washing the non-woven fabric.

13. The method according to claim 9, wherein the surface of the buffer layer is flattened by grinding in step (b).

14. The method according to claim 13, wherein the unflatness percentage of the flattened surface is less than 6%.

15. The method according to claim 13, further comprising a step of smoothing the flattened surface after the grinding step.

16. The method according to claim 9, wherein step (c) comprises the following steps of:
(c1) providing a carrier;
(c2) coating a polymer composition on the carrier;
(c3) solidifying the polymer composition to form the polishing layer;
(c4) separating the carrier and the polishing layer; and
(c5) attaching the polishing layer on the flattened surface.

17. The method according to claim 16, wherein the carrier in step (c1) is an impermeable film.

18. The method according to claim 16, wherein the material of the carrier in step (c1) is selected from a group consisting of PET, OPP, TPE, PS, PP, PE, PU, or a combination thereof.

19. The method according to claim 16, further comprising a step of grinding and leveling the polishing layer after step (c3).

20. The method according to claim 19, wherein a surface of the carrier after the grinding step is a smooth surface or a gloss surface.

21. The method according to claim 16, wherein in step (c4) the carrier and the polishing layer are separated through a mechanical physical manner.

22. The method according to claim 16, wherein in step (c4) the carrier and the polishing layer are separated through a chemical manner.

23. The method according to claim 16, further comprising a step of grinding and leveling the polishing layer after step (c5).

24. The method according to claim 9, wherein step (c) comprises the following steps of:
(c1) coating a polymer composition on the flattened surface; and
(c2) solidifying the polymer composition so as to form the polishing layer.

25. The method according to claim 24, further comprising a step of grinding and leveling the polishing layer after step (c2).

26. The method according to claim 9, further comprising a step of forming a plurality of grooves on the polishing layer after step (c).
